(19) United States
(12) Patent Application Publication
(10) Pub. No.: US 2009/0123891 A1
(43) Pub. Date: May 14, 2009

(54) COMPOSITE DENTAL IMPLANT SYSTEM

(76) Inventor: Jeffrey M. Rosenberg, Wynnewood, PA (US)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 11/939,977

(22) Filed: Nov. 14, 2007

(51) Int. Cl. A61C 8/00

(52) U.S. Cl. 433/174

(57) ABSTRACT

A resin tooth prosthesis system for an implant fixture that is engaged with bone, a composite resin abutment for engaging the implant fixture, and a composite resin replacement tooth prosthesis. The abutment has the same or similar resin as the tooth prosthesis, providing a highly durable connection that can withstand high stresses associated with chewing. Several arrangements are provided for connecting the abutment to the implant, and free-hand and molding techniques are disclosed whereby the practitioner manufactures (i.e., molds and cures) a replacement tooth within the patient's mouth, speeding the overall replacement process and reducing the expense. The replacement tooth may be sculptable to enable slight adjustments of the prosthesis shape after it has been cured. A method for installing the system, as well as a multi-piece kit for providing the system to practitioners, are also provided.

### FIELD OF THE INVENTION

The invention generally relates to replacement dental implant prostheses, and more particularly to a system and method for providing an improved composite resin implant abutment dental prosthesis.

### BACKGROUND

A variety of techniques have been employed to replace or repair damaged, decayed, lost, or removed teeth. The use of complete or removable partial dentures is well-known, as is the use of temporary or permanent crowns. More recently, multi-component replacement teeth have been developed for applications in which one or more teeth are lost or have been completely removed. These multi-component replacement teeth consist of an implant fixture engaged in the mandible or maxilla by a surgical procedure, an abutment that is fixed to the implant, for example using a threaded fastener, and a replacement tooth that engages the abutment and typically is fixed to the abutment using cement or another fastener. To install these multi-component systems, the implant is first inserted into the alveolar cavity and must be held there for a period sufficient to allow bone to grow into contact with the implant to fix the it firmly in place. Thereafter, the abutment and replacement tooth can be installed on top of the implant to form the finished prosthesis.

Typically the implant part and the abutment are formed of a metal material, such as titanium, which has desired high strength and is also biocompatible. More recently, abutments have also been fabricated from ceramic and/or zirconium materials. The replacement tooth is usually a metal, a metal-ceramic, a ceramic or cured polymer, manufactured from a mold of the patient's original tooth, the abutment, a replica of the abutment, and a molding of the jaw, or from a substitute that is chosen as an approximation thereof. One benefit of such multi-component systems is that if the replacement tooth or the abutment break, they can be removed and replaced without requiring a new implant to be installed.

While multi-component systems as described provide advantages over traditional bridges or caps, they also have disadvantages. For example, the metal, metal-ceramic, ceramic or cured polymer replacement teeth are not manufactured or chosen at the dentist's office, which would require an investment either in equipment or in an inventory of replacement teeth from which the right size, shape, color, etc. could be selected. Instead, the replacement teeth are made off-site based on molds taken or specifications provided by the practitioner. Substantial time delays can be involved in providing a patient with a finished replacement tooth. Additionally, in a case where the device breaks in use (which can happen due to the substantial forces applied to the system during chewing), the breakage is often at the screw that attaches the abutment to the implant, since that it is usually the weakest link in the system. This typically results in a portion of the screw shank being stuck within the screw cavity of the implant. Special tools may need to be used to remove the screw piece so that another screw can be inserted to attach a replacement abutment to which a newly manufactured tooth is then cemented.

There is a need for a high-strength multi-piece implant system that incorporates composite resin materials that are curable in-situ, which system is less expensive than traditional systems, and which can be easily removed and replaced if one or more components experience failure during the lifetime of the system.

### SUMMARY OF THE INVENTION

The disadvantages heretofore associated with the prior art are overcome by the inventive design for a single or multi-piece composite resin implant abutment prosthesis.

A replacement tooth prosthesis system is disclosed, comprising an elongated implant fixture, a resin abutment member engaged with the implant fixture, and a replacement tooth prosthesis engaged with the abutment. The replacement tooth prosthesis may comprise a composite resin material, and the resin abutment member may be chemically compatible with the composite resin material of the replacement tooth prosthesis.

A tooth prosthesis system is disclosed, comprising an implant fixture having a bone engaging portion and an abutment engaging portion, a resin abutment having an implant engaging portion and a prosthesis engaging portion, and a replacement tooth prosthesis comprising a composite resin material. The replacement tooth prosthesis may be engaged with the prosthesis engaging portion of the resin abutment via cross-linking of the resins.

A method for replacing a lost, damaged or removed tooth is disclosed, comprising: providing an implant fixture and a resin abutment member; inserting the implant fixture into a recess in the mandible or maxilla of a patient, fixing the resin abutment member to an upper surface of the implant fixture, applying a composite resin tooth prosthesis to an upper surface of the resin abutment member, and applying UV light to a surface of the composite resin tooth prosthesis to cure the prosthesis and to bond the prosthesis to the resin abutment.

A replacement tooth prosthesis kit is disclosed. The kit may include a plurality of resin abutment members, at least one of the abutment members having a size or shape different from at least one other abutment member. The kit may further include a plurality of sizing shells configured to measure a size or shape of a tooth vacancy site. Additionally, a plurality of tooth prosthesis molds may be provided. Each mold may correspond in size or shape to at least one of the plurality of sizing shells. A quantity of composite resin material may also be provided with the kit. The kit may also include a transfer coping to transfer the abutment size, shape and position for indirect fabrication of the dental prosthesis.

### BRIEF DESCRIPTION OF THE DRAWINGS

The details of the invention, both as to its structure and operation, may be obtained by a review of the accompanying drawings, in which like reference numerals refer to like parts, and in which:

FIG. 1 is a cross-section view of an exemplary assembled replacement tooth prosthesis system;

FIG. 2A is a cross-section view of an implant fixture portion of the system of FIG. 1; FIGS. 2B and 2C are partial isometric views of a top surface of the implant fixture portion of FIG. 2A showing alternative geometric configurations for mating with an abutment portion of the system of FIG. 1;

FIG. 3A is a cross-section view of an abutment portion of the system of FIG. 1; FIGS. 3B and 3C are partial isometric views of a bottom surface of the abutment portion of FIG. 3A showing exemplary geometric configurations for mating with the implant fixture portions of FIGS. 2B and 2C, respectively;

FIG. 4 is a cross-section of a tooth prosthesis portion of the system of FIG. 1;

FIG. 5 is a cross-section view of a transfer coping arrangement for use in forming a tooth prosthesis using a traditional indirect method;

FIG. 6 is an isometric view of the assembled replacement tooth prosthesis system of FIG. 1 implanted in the mandible of a patient;

FIG. 7 is a cross-section view of an alternative engagement scheme for an abutment and implant fixture for use with the system of FIG. 1;

FIG. 8 is a cross-section view of a further alternative arrangement scheme for an abutment and implant fixture for use with the system of FIG. 1;

FIG. 9 is a cross-section view of still another alternative arrangement scheme for an abutment and implant fixture for use with the system of FIG. 1;

FIG. 10 is a cross-section view an alternative two-piece abutment for use with the system of FIG. 1;

FIG. 11 shows a kit for use by a practitioner in employing the system of FIG. 1;

FIG. 12 shows an inter-fitting arrangement between an abutment and a tooth prosthesis mold;

FIG. 13 shows the abutment and tooth prosthesis mold fit together;

FIGS. 14A-C show a snap-in engagement between the abutment and a pre-formed tooth prosthesis.

### DETAILED DESCRIPTION

A new system and method for providing a composite resin implant abutment tooth prosthesis is disclosed, comprising an implant fixture, a composite resin abutment, and a composite resin replacement tooth prosthesis. The implant fixture may be metal and may be designed to engage patient bone in a conventional manner. The composite resin abutment is fixable to the implant fixture via a screwed connection, or by a snap-fit configuration that may allow a quick connection to the implant fixture. Desirably, the resin selected for the abutment will be biocompatible and chemically compatible with the resin selected for the replacement tooth prosthesis to ensure good long term engagement between the two. The replacement tooth prosthesis may be pre-molded and cured prior to engagement with the composite resin abutment, or it may comprise a partially shaped volume of uncured resin that can be formed, applied to the abutment and shaped in-situ, then cured in the patient's mouth. Post-cure sculpting of the replacement tooth prosthesis may be effected by the practitioner to provide a final desired tooth shape. Tinting of the final tooth can also be performed.

The benefits of making both the replacement tooth prosthesis and the abutment from a composite resin are numerous. It enhances the engagement between the abutment and the replacement tooth prosthesis (due to the cross-linking which occurs between the resins of the two pieces). It also facilitates in-situ formation/curing of the replacement tooth prosthesis, thus potentially eliminating the need for the replacement tooth prosthesis to be outsourced to a third party manufacturer (required when using ceramic replacement teeth). Additionally, by making the abutment from resin in lieu of metal, the abutment becomes the “weak point” in the system (as opposed to the fixation screw, which will still be metal). As a result, if the system experiences failure during use, the abutment will break before the screw. It is then a relatively simple procedure to remove the broken abutment by unscrewing the screw and replacing the abutment and tooth prosthesis with new pieces.

For the purposes of this application, the term “composite resin” shall mean any of a variety of low shrinkage, polymerizable dental resins. As will be described in greater detail later, the basic resin may be combined with any of a variety of additives, fillers (e.g., particulate and/or fibers), coupling agents, pigments, and the like. Additionally, the resin may be light-curable, chemically curable, or a combination of the two (“dual cured”). In one embodiment the resin will comprise bis-GMA material.

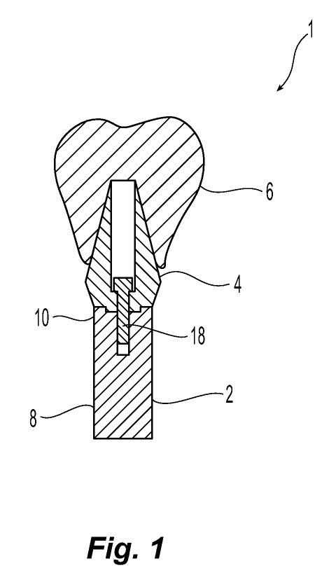

Referring now to FIGS. 1-4, the composite-resin dental implant abutment/prosthesis system 1 will be described in greater detail. As noted, the system 1 may comprise an implant fixture 2, a composite resin abutment 4 and a replacement tooth prosthesis 6. The implant fixture 2 may be an elongated member having a bone engaging portion 8 at a first end and an abutment engaging portion 10 at an opposite end. The bone engaging portion 8 may be sized and shaped to be received within a targeted alveolus of a patient's mandible or maxilla, and may have a surface finish (e.g., knurled, grit blasted) configured to enhance engagement with bone. The bone engaging portion 8 may further have a bioactive surface treatment to enhance integration with the bone (i.e., “osseointegration”).

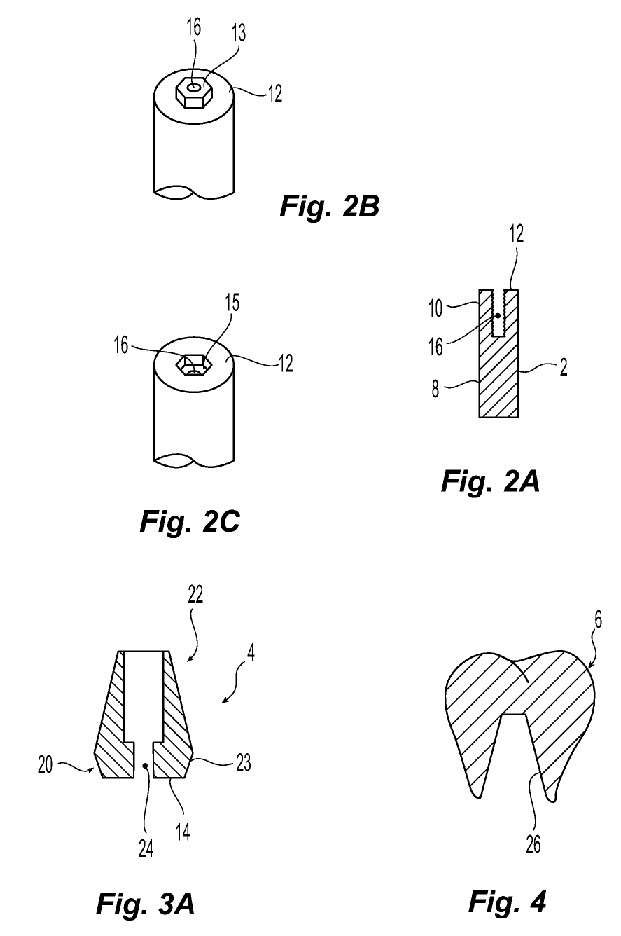

Referring to FIG. 2A, the abutment engaging portion 10 may comprise an end surface 12 shaped and configured to receive a correspondingly shaped surface 14 of the composite resin abutment 4 to provide a stable bearing between the pieces in use. In one embodiment, the end surface 12 may be a flat surface surrounding a blind hole 16, sized to accept a fastener 18 for mechanically fixing the composite resin abutment 4 to the implant fixture 2. In the illustrated embodiment, the fastener 18 is a machine screw, and the blind hole 16 has threads that are complementary to the threads of the machine screw. It will be appreciated that other fasteners may also be appropriate, such as bayonet clip-style fastener, or the like. Although fasteners used in these applications are predominately screw retained, the implant/abutment inter-engagement designs may also employ a friction fit.

Referring to FIGS. 2B and 2C, alternatives to the flat end surface 12 are shown. It is important that the implant fixture 2 and abutment 4 remain rotationally fixed during use to ensure a proper long term desired alignment of the tooth prosthesis 6 and to minimize the chance for loosening of the fastener 18. Thus, the end surface 12 of the implant fixture may comprise either a raised geometric projection 13 (FIG. 2B), or a geometric recess 15 (FIG. 2C) that will be sized and shaped to correspond with a similar surface of the abutment 4. In the illustrated embodiments, the geometric projection and recess 13, 15 are hexagonal in shape. It will be appreciated that any other appropriate geometric shape may be used (e.g., rectangular, triangular, oval) to ensure non-rotation of the abutment 4 with respect to the implant 2 during use.

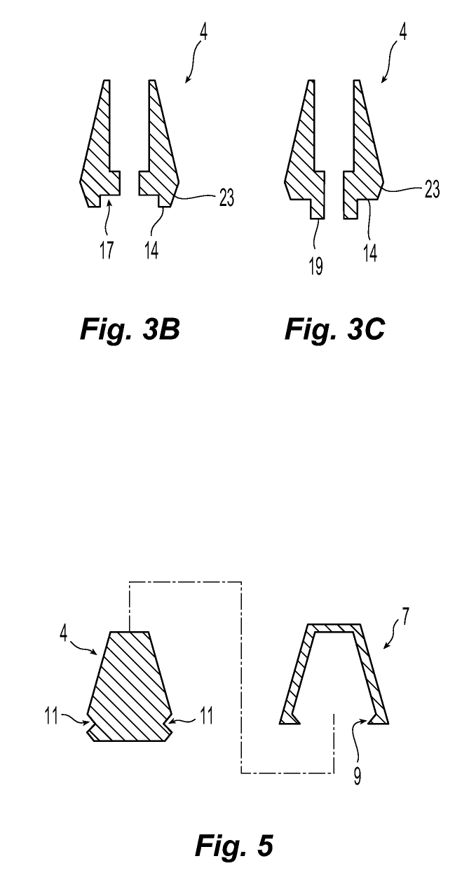

Referring now to FIG. 3A, the composite resin abutment 4 may have an implant fixture engaging portion 20 at a first end and a replacement tooth prosthesis engaging portion 22 at an opposite end. The implant fixture engaging portion 20 may comprise a surface 14 that conforms to the end surface 12 of the implant fixture 2. The end surface 14 may be flat to match a flat end surface 12 of the implant fixture 2, or the end surface 14 may comprise a geometric recess 17 (FIG. 3B) or projection 19 (FIG. 3C) configured to mate with a similarly shaped projection 13 or recess 15 of the implant fixture. It may desirable that surface 14 be in close approximation in size and shape to existing manufacturer's fixture systems, which employ various sizes and shapes in the form of external geometric shapes (triangle, square, hex, etc.) or internal geometric shapes of the same type. The hole 24 will preferably be smaller than the diameter of the head of the fastener 18 so that the head will bear on the abutment 4 when the screw is tightened, pressing it into engagement with the implant fixture 2. Although complementary flat surfaces 12, 14 are described, will be appreciated, however, that a number of complementary surfaces 12, 20 may be used to ensure a desired alignment of the abutment 4 on the implant fixture 2. For example, the surfaces could be correspondingly grooved, stepped, or arcuate.

The prosthesis engaging portion 22 of the composite resin abutment 4 should be shaped to provide a large surface area for bonding with the prosthesis 6. In the illustrated embodiment, this portion is shown as having a conical surface, which may be beneficial because it may enable the spreading of forces over a large portion of the abutment 4. It will be appreciated, however, that other appropriate surface configurations may also be used to desirable effect, and thus cylindrical, stepped, and curved surfaces may also be used. The prosthesis engaging portion 22 may have a highly smooth or polished portion 23 located directly adjacent to the implant engaging portion 20. This smooth portion is positioned so that it will lie directly adjacent the patient's gum tissue upon installation so as to minimize the chance for bacterial buildup and gum irritation during use.

Referring now to FIG. 4, the replacement tooth prosthesis 6 may comprise a volume of composite resin that is shaped, or is shapeable, to assume the form of the tooth that it is replacing. In one embodiment, the prosthesis 6 can be at least partly pre-formed and cured prior to engagement with the abutment 4. Alternatively, the prosthesis 6 may be molded or otherwise wholly formed and cured inside the patient's mouth.

In one exemplary embodiment, the replacement tooth prosthesis 6 is formed using a mold and cured prior to placement in the patient's mouth. The prosthesis of this embodiment will be formed with an abutment-engaging surface 26 that corresponds to the prosthesis-engaging surface 22 of the abutment 4. The prosthesis 6 may be fixed to the abutment 4 using an appropriate cement at the interface between the two surfaces 22, 26.

In another exemplary embodiment, the replacement tooth prosthesis 6 may be formed within the patient's mouth. In this embodiment, an appropriately sized and shaped mold may be placed over the abutment 4 (which has already been fixed to the implant fixture 2) and a quantity of uncured composite resin material may be poured or packed into the mold. The composite resin material may then be cured using light energy such as ultraviolet (UV), light emitting diode (LED), quartz halogen, plasma arc or laser light sources. The composite resin may also be chemically cured, or it could be “dual-cured,” meaning that a chemical curing process is instigated by the application of light energy. to form the finished or semi-finished replacement tooth prosthesis 6. Final finishing of the prosthesis 6 (e.g., by shaving, grinding or carving, as well as by adding further material to fill or enlarge its shape, followed by curing and additional material removal as necessary) may be performed by the practitioner to obtain a final desired tooth form.

In a further embodiment, the prosthesis 6 may be formed directly on the abutment 4 without a mold. Thus, a quantity of composite resin material may be roughly formed and pressed onto the prosthesis engaging surface 22 of the abutment. The resin may then be cured to create a rough-form prosthesis. The rough-form prosthesis may then be sculpted (by shaving, grinding or carving) to obtain the final desired tooth form.

Of course, traditional indirect methods of replacement tooth fabrication can also be used with the disclosed system as well. Referring to FIG. 5 a fitted coping of the abutment (referred to as a transfer coping 7), may be placed over the abutment 4 such that one or more projections 9 on a lower inner surface of the transfer coping 7 snap into one or more circumferential grooves 11 formed on the abutment 4. An impression of the region may then be obtained using a standard impression technique. An analog of the abutment may then be snapped onto the transfer coping 7, and a solid mould formed. A metal, metal-ceramic, ceramic, polymer or resin crown may then be fabricated on the mould. The completed prosthesis may then be snapped onto the abutment 4 and cemented in place.

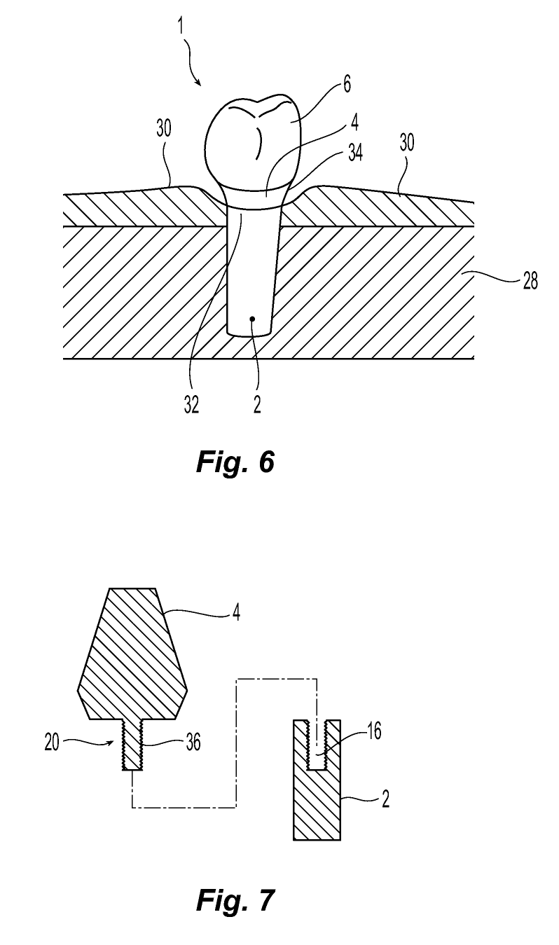

Referring to FIG. 6, the composite-resin dental implant abutment/prosthesis system 1 is shown assembled in the mandible 28 of a patient. As can be seen, the patient's gum line 30 intersects the system 1 at or near the interface between the implant fixture 2 and the abutment 4. To minimize irritation of the gum, the exterior surfaces 32, 34 of the implant fixture 2 and abutment 4 may be very smooth.

As previously noted, the abutment 4 and replacement tooth prosthesis 6 will be made from a composite resin material. The composite resin material may comprise a mixture of relatively soft, organic resin matrix (polymer) in combination with relatively hard, inorganic filler particles or fibers. Other components (e.g., initiators, stabilizers) may also be included to improve the efficacy of the combination and to initiate polymerization. The basic resin material may comprise a monomer such as Bis-GMA, urethane dimethacrylate (UEDMA), or triethylene glycol dimethacrylate (TEGDMA). Bis-GMA may be extremely viscous at room temperature due to hydrogen bonding by hydroxyl groups. Thus, to facilitate the addition of desired filler materials, lower viscosities may be obtained by mixing Bis-GMA with dimethacrylate monomers (TEGDMA) of lower molecular weight. The addition of diluents also allows a greater degree of conversion and more extensive cross-linking to occur between chains, providing a matrix that is more resistant to solvents.

Examples of appropriate particulate filler materials include, but are not limited to, inorganic metal, salt, oxide, nitride, silicate glass, aluminosilicate glass, aluminoborosilicate glass, fluoroaluminosilicate glass, quartz, colloidal silica, precipitated silica, zirconia-silica, polymeric filler, polymerized composite filler with inorganic particles, and combinations thereof. Additionally, a variety of different sizes of filler materials can be used, including megafillers (0.5 to 2 millimeters), macrofillers (10 to 100 microns), midifillers (1 to 10 microns), minifillers (0.1 to 1.0 microns), microfillers (0.01 to 0.1 microns), and nanofillers (0.005 to 0.01 microns). Mixtures of different particle sizes (referred to as “hybrid filler particles”) can also be used.

It will be appreciated that very small particle sizes (microfillers and nanofillers) may have extremely large total surface areas that may demand much more resin matrix to “wet” their surfaces. This may create extremely high viscosities that limit the total percentage of filler content. Thus, to maximize filler loading and minimize viscosity, prepolymerized resin and microfiller may be used. The heavily filled polymerized resin may be ground into 30-65 micron particles and mixed with more resin and microfiller to provide a composite that is filled 30 to 50% by volume.

One exemplary filler is barium glass having average particle size of 0.6 to 1.0 micron. A small amount of microfiller may be added to improve handling characteristics and reduce stickiness. To incorporate a maximum amount of filler into a resin matrix, it may be necessary to use filler particles having a distribution of different particle sizes. These so-called hybrids are potentially superior because increased filler loading improves the stress transfer between particles in the composite, thus improving prosthesis strength and characteristics. In one embodiment, minifill hybrids may be used with nanofillers.

In addition to particulate fillers, a variety of sizes, types and formulations of fibrous materials may be added to the resin material to increase overall strength of the resulting replacement tooth prosthesis. Examples of appropriate fibers include chopped quartz fibers, silica-based (i.e., glass) fibers, as well as Kevlar (aramid) and polycarbonate fibers, ceramic fibers, metallic fibers, carbon fibers, graphite fibers, polymeric fibers such as cellulose, polyamide, aramid, polyester, polyaramid, acrylic, vinyl and modacrylic, polyolefin, polytetrafluorethylene, and combinations thereof, as well as other fibers known in the art

To facilitate efficient bonding of the filler materials (particulate as well as fibers) to the resin matrix, a coupling agent may be employed. The most commonly used coupling agent is an organosilane such as gamma-methacryloxypropyltrimethoxy silane. The silane reduces hydrolytic breakdown and allows stress transfer between the filler and the matrix. The silane agent is a bifunctional molecule with a methacrylate group on one end and a silanol group on the other. The methacrylate end undergoes addition polymerization with the composite resin and the silanol end bonds to the hydroxyl groups on the filler particle via a condensation reaction.

The composite resins are polymerized chemically, and curing may be effected in a number of ways. The reaction may be initiated with a catalyst via mechanical mixing of the base resin with the catalyst, or a photosensitive catalyst (traditionally a tertiary amine radical) such as camphorquinone (CQ). Hardening of the composite resin may be achieved through free-radical polymerization of the (meth)acrylate monomers using a photoinitiator, a heat-cure initiator, or a redox initiator system.

As will be appreciated, the formulation and additive composition of the composite resin material may be the same for both the abutment 4 and the prosthesis 6, or it may be different. This will also be true for the additives incorporated into with the resin.

Alternatively, where it is desirable that the abutment 4 retain high strength characteristics of metal, the abutment 4 may comprise a metal core (e.g., titanium, zirconium) encased in an external coating of composite resin material. This embodiment may combine the strength benefits of metal with the enhanced prosthesis-engaging benefit of composite resin. In order to facilitate a tight and long lasting bond between the resin and underlying metal, the metal surface can be formed treated to provide surface irregularities that will provide a high degree of mechanical coupling with the resin. Thus, where the abutment is molded or cast, the mold or cast may comprise surface irregularities that will transfer to the abutment surface. These irregularities may take the form of voids left after the wash out of salt crystals, spheres or meshwork. Additionally, surface conditioning via mechanical abrasion (e.g., air abrasion using alumina particles), or etching (either electrolytic or chemical) can be employed to produce surface finishes on the final surface that greatly increase the surface area available for resin bonding and mechanical attachment.

Such surface conditioning can also be employed on the finished surface 22 of the resin abutment 4 to facilitate bonding with the resin of the replacement tooth prosthesis 6.

It is further contemplated that the replacement tooth prosthesis 6 could have a non-resin core, or it could have a core made from a resin having a different composition than the resin used on the surface.

The implant fixture 2 and fastener 18 may be made from an appropriate high strength material, such as metal. Titanium and zirconium are two materials that have good long-term strength and biocompatibility characteristics. Alternatively, the implant fixture 2 and/or fastener 18 may be made from a suitable non-metallic material. In one embodiment, the implant fixture 2 is made from a composite resin material having similar properties to that of the abutment 4 and replacement tooth prosthesis 6.

In the embodiment described in relation to FIGS. 1-6, the abutment 4 and implant fixture 2 have been described as being fixed together using a screw 18. This is but one possible configuration, and various alternatives are contemplated. For example, as shown in FIG. 7, the implant fixture-engaging portion 20 of the abutment 4 may comprise a threaded extension 36 sized and configured to directly engage the threads of the hole 16 in the implant fixture 2. This may simplify the system 1 by eliminating the separate screw 18, thus reducing overall manufacturing and acquisition costs for the system 1.

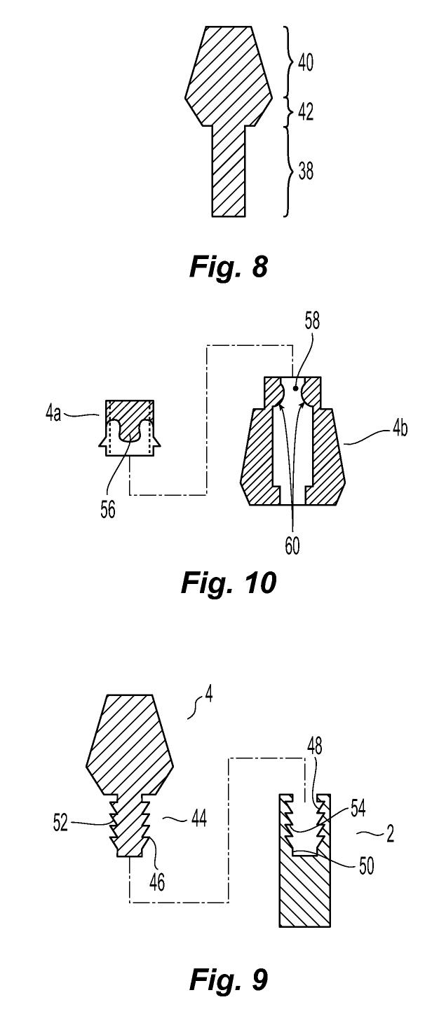

As a further simplification the implant 2 and abutment 4 may be provided as a single piece as shown in FIG. 8. Thus, the implant/abutment could comprise a single piece of metal (titanium, zirconium or the like) in which the bone-engaging surface 38 of the implant is roughened or knurled to enhance engagement with the bone of the mandible or maxilla, and where the tooth prosthesis engaging portion 40 has a composite resin coating. An intermediate portion 42 of the implant/abutment may have a smooth surface for minimizing the chance of irritation to the surrounding gum material.

In an additional alternative, a ratchet-fit feature may be provided between the abutment 4 and implant 2. Referring to FIG. 9, the implant fixture-engaging portion 20 of the abutment 4 may comprise an extension 44 having a plurality of ratchet teeth 46 that may cooperate with complementary shaped projections 48 disposed on an interior wall portion 50 the implant fixture 2. Thus, in this embodiment the abutment 4 can be engaged with the implant 2 merely by aligning the extension 37 over the implant fixture 2 and pressing down, forcing the ratchet teeth 46 of the abutment to pass by the projections 48 of the implant fixture 2. Corresponding flat surfaces 52, 54 on the abutment and implant fixture would thereafter prevent reverse movement between the pieces, locking them together.

Further, the abutment 4 may be provided in two pieces 4A, 4B, one of which (4B) may engage the implant fixture 2 and the other of which (4A) may engage the replacement tooth prosthesis 6. This embodiment, shown in FIG. 10, includes a snap-fit connection between the two pieces 4A, 4B. As shown, a depending bulb 56 centrally disposed within a recess 58 in the first piece 4A interferes with an annular shoulder 60 of the second piece. When the first piece 4A is aligned over the second piece 4B such that the depending bulb 56 is received within a top recess portion 58 of the second piece, downward pressure applied to the first piece 4A may cause the bulb 56 to pass by the annular shoulder 60 via slight elastic deformation of the bulb, the shoulder, or both. Once the bulb 56 passes the shoulder, return motion of the first piece 4A is prevented via the aforementioned interference, and the first and second pieces 4A, 4B are locked together. It will be appreciated that other connection schemes may also be used to lock the pieces 4A, 4B together, such as ratchets, cementing, screwing, and the like.

The benefit of the FIG. 10 arrangement is that may enable the abutment 4 to be provided with two different materials. Thus, the first piece 4A may be provided as a composite resin material (to provide enhanced engagement with the replacement tooth prosthesis 6), while the second piece 4B may be provided as a metal material (or a resin-coated metal) to provide superior strength for engaging the implant fixture 2.

Where the abutment 4 is made from titanium or zirconium coated with composite resin, the titanium surface may be mechanically or chemically roughened to enhance the connection between titanium and resin materials. Even in cases in which the abutment 4 is made from composite resin, or resin-coated metal, the surface of the resin may likewise be mechanically or chemically roughened to enhance the bond between the abutment 4 and the prosthesis 6. Appropriate roughening techniques may comprise acid etching or mechanical abrasion (e.g., blasting with alumina particles). Alternatively, the pieces may be machined (in the case of metal) or molded (in the case of resin) to have a knurled surface that similarly enhances engagement with the composite resin tooth prosthesis 6.

As previously noted, the implant fixture 2 may be provided with a knurled or roughened surface to enhance engagement with the surrounding bone. In addition, the bone engaging surface 8 of the implant fixture 2 may have a coating that incorporates bone growth enhancing materials and/or antibiotics.

To install the system 1 in a patient, the missing tooth site is located and a drill is used to drill a hole of desired geometry (typically cylindrical) in the patient's mandible or maxilla. The hole may be sized to enable the implant fixture 2 to be installed with a press-fit. The implant is pressed down so that the top surface 12 of the implant fixture 2 is generally aligned with the level of the gum (see FIG. 6). The implant fixture 2 is then allowed to remain in place for a period sufficient to allow bone to grow around the fixture 2 to firmly fix it within the hole.

Once the implant is sufficiently fixed within the bone, the appropriate abutment 4 may be selected and fixed to the implant using one of the aforementioned techniques or arrangements. The composite resin tooth prosthesis 6 may then be mounted on the abutment 4. As previously noted, this may be accomplished in a variety of ways.

In a first example, a quantity of composite resin material may be formed by the practitioner into a size and/or shape roughly approximating the original tooth. This quantity of resin may be pressed down onto the prosthesis engaging portion 22 of the abutment. The resin can be reshaped slightly once it is engaged with the abutment if distortions occur due to the pressing operation. Where the resin comprises bis-GMA, a source of light energy can then be introduced adjacent to the patient's mouth to cure the resin into a rough tooth prosthesis. This curing process may take up to about 2 minutes. The application of light energy will cure the resin prosthesis, and will also cause the resin to cross-link with the resin of the abutment 4, providing a high strength bond between the two pieces that will make the prosthesis highly durable. After the rough prosthesis has been cured (i.e., hardened), the practitioner can use appropriate tools to shave, grind or otherwise sculpt the resin into a finished tooth shape. The prosthesis can then be tinted as desired.

In lieu of providing a rough quantity of resin material over the abutment 4, a mold may be used. With this embodiment, the practitioner may place the mold within the patient's mouth, aligning it over the installed abutment 4. The mold may then be packed with composite resin material and cured with light energy or other appropriate curing technique. This arrangement may provide a more finished appearance to the cured prosthesis 6, thereby minimizing post-cure reworking of the prosthesis. Additionally, where the mold is provided with very smooth inner surfaces, the resulting tooth prosthesis 6 may also be extremely smooth. As a result, if the prosthesis contacts the patient's gum, it will be less likely to cause irritation. In one embodiment, the mold is made from Mylar or other material with a similarly smooth surface. Using a Mylar mold may be desirable because it eliminates the need to form a discrete “finish” line on the abutment or tooth prosthesis, because the entirety of the molded prosthesis will be smooth enough to minimize gum irritation and bacterial buildup.

Although the chemical properties of the resin material used to form (or coat) the abutment 4 will be sufficient to provide a tight bond to the resin material used to form the prosthesis, it may be desirable to slightly roughen the outer surface of the abutment to enhance the mechanical connection between the pieces. This can be done by the manufacturer, or it can be performed by the practitioner using an air abrader (sandblaster) using aluminum oxide particles. Alternatively, a dilute acid may also be used.

Where a mold is used to form the prosthesis 6, it may be provided as part of a kit comprising a plurality of individual molds from which the practitioner can select the appropriate size and shape mold to fit the individual patient's anatomy. Alternatively, the practitioner may fashion a patient-specific mold using sheet Mylar or similar ultra-smooth surfaced material.

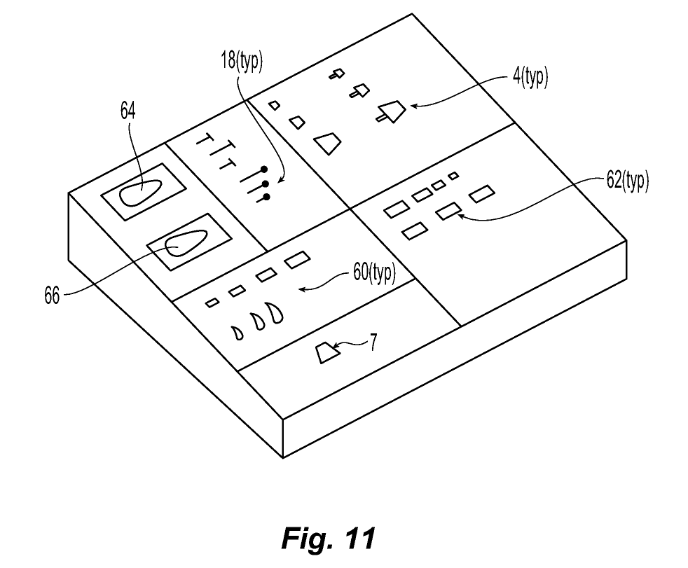

As a further embodiment, a comprehensive kit may be provided to facilitate fast and easy selection and application of the composite resin dental implant abutment prosthesis system 1. Referring to FIG. 11, a kit may be provided that includes a plurality of abutments 4 to engage an implant fixture, and a plurality of molds 60 suitable for forming a wide variety of tooth shapes (e.g., molar, incisor) and sizes. Additionally, the kit may comprise a plurality of sizing “shells” 62 to allow the practitioner to quickly determine which size mold should be selected. For example, the practitioner may select an 8 millimeter (mm) shell 62 and trial fit it into the space between adjacent healthy teeth to determine whether the selected size will provide the most desired fit. This trial fit process will likely involve the selection of several different sized shells prior to finding the right one. The sizing shells may be color coded to easily select the corresponding final mold form. Once the appropriate shell size is determined, the mold 60 corresponding to that shell is selected and placed over the already-installed abutment 4. A predetermined quantity of composite resin material 64 may be provided. Additionally, a predetermined quantity of resin cement 66 may also be provided for cementing a pre-formed tooth prosthesis to a selected abutment 4. Composite resin material is packed into the mold 60 and cured in a manner similar to that described in relation to the previous embodiment.

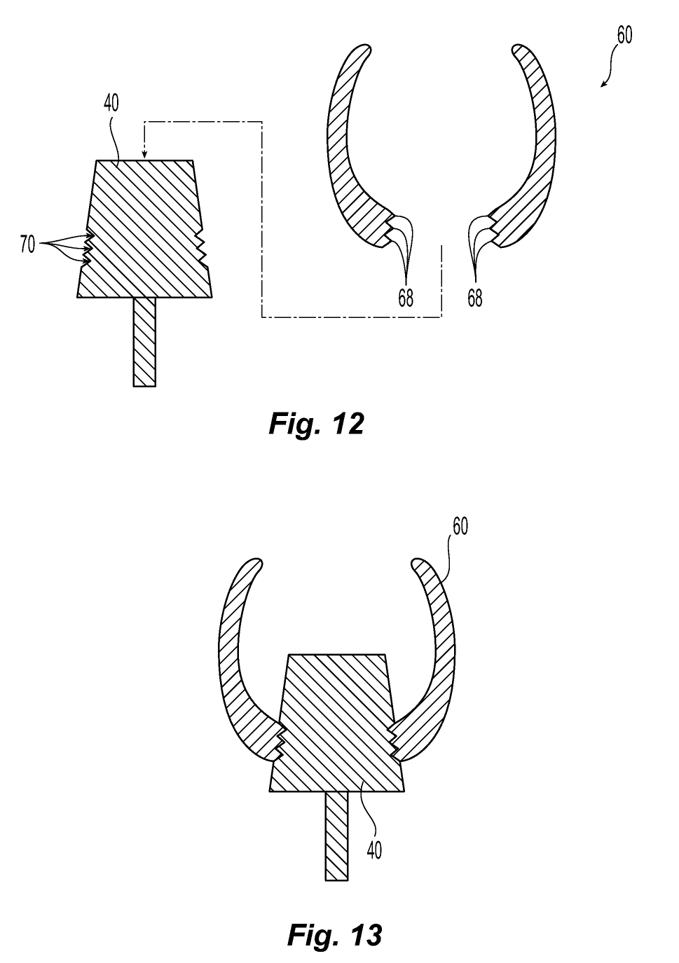

The molds 60 may also be configured to snap or lock onto the abutment 4 at or near the patient's gum line. Thus, as shown in FIGS. 12 and 13, one or more projections 68 on the mold 60 may mate with a correspondingly shaped recess 70 on the abutment 4. This mating may create a snap fit/seal which expresses out excess resin or cement as the mold is seated into place, thus facilitating quick cleanup with a minimum of finishing and shaping, and results in a reduction or elimination of subsequent gingival irritation.

In addition to the above described techniques, it will be appreciated that a conventionally manufactured prosthesis (e.g., porcelain) could be fit onto the composite resin abutment 4 as desired by the particular patient and/or practitioner.

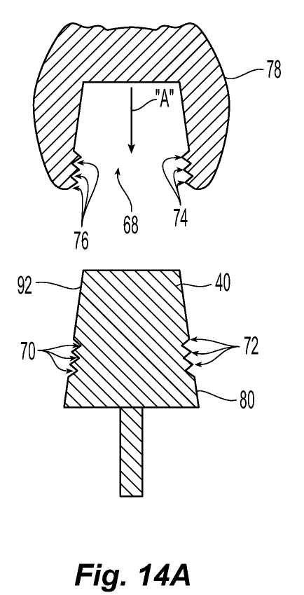

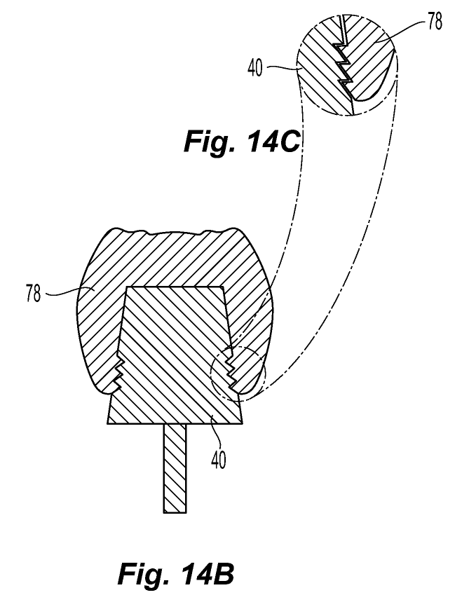

Referring to FIGS. 14A-C, an interfitting arrangement between a pre-manufactured tooth prosthesis 78 and abutment 40 may include a snap-fit feature in which the abutment 40 may have one or more circumferentially disposed projections 72 and recesses 70 configured to mechanically couple to corresponding projections 74 and recesses 76 of the replacement tooth prosthesis 78. The projections and recesses of the abutment 40 may be located just above the smooth surface region 80 such that when the replacement tooth prosthesis 78 is fully engaged with the abutment 40, the smooth surface region 42 remains adjacent the patient's gum line.

The projections may be configured to create a positive seat and seal when the tooth prosthesis 78 is fully engaged with the abutment 40. The positive sealing enables excess resin to be expressed out from between the prosthesis and abutment for easy cleanup. As shown in FIG. 14A, the replacement tooth prosthesis 78 may be aligned with the abutment 40 such that the recess 90 of the prosthesis 78 is aligned with the tooth prosthesis engaging portion 92 of the abutment 34. Pressing down on the prosthesis 78 in the direction of arrow “A” causes the respective projections and recesses of the prosthesis 78 and abutment 40 to engage. By continuing to apply force along direction “A”, the prosthesis may be set in the fully seated position shown in FIG. 14B. If a resin cement is used between the abutment and the prosthesis, any excess resin will be expressed out of the margin of the seated prosthesis for easy cleanup.

An additional benefit of the disclosed system is that it is inherently flexible in that the practitioner is provided with a variety of options in creating a replacement tooth immediately. Additionally, the use of composite resin enables the practitioner to add or subtract material from the prosthesis 6 at any point in the installation process.

It will be understood that the description and drawings presented herein represent an embodiment of the invention, and are therefore merely representative of the subject matter that is broadly contemplated by the invention. It will be further understood that the scope of the present invention encompasses other embodiments that may become obvious to those skilled in the art, and that the scope of the invention is accordingly limited by nothing other than the appended claims.

1. A replacement tooth prosthesis system, comprising:
a resin abutment member engageable with an implant fixture; and
a replacement tooth prosthesis engaged with said abutment;
wherein the replacement tooth prosthesis comprises a composite resin material, and the resin abutment member is chemically compatible with the composite resin material of the replacement tooth prosthesis.

2. The replacement tooth prosthesis system of claim 1, wherein the composite resin material comprises bis-GMA.

3. The replacement tooth prosthesis system of claim 1, wherein the implant fixture and abutment are fixed together by a threaded fastener having a shear strength that is greater than a shear strength of said resin abutment.

4. The replacement tooth prosthesis system of claim 1, wherein the engagement between the abutment and the replacement tooth prosthesis comprises cross-linking of said composite resin material.

5. The replacement tooth prosthesis system of claim 1, wherein the abutment comprises first and second portions that are removably connectable to each other, the first portion comprising metal and the second portion comprising said composite resin material.

6. The replacement tooth prosthesis system of claim 1, wherein the composite resin material is responsive to light energy such that the application of ultraviolet (UV), halogen, light emitting diode (LED), plasma arc, or laser light to a surface of the resin material configures at least a portion of the resin material to a cured state.

7. A tooth prosthesis system, comprising:
an implant fixture having a bone engaging portion and an abutment engaging portion;
an resin abutment having an implant engaging portion and a prosthesis engaging portion; and
a replacement tooth prosthesis comprising a composite resin material;
wherein the replacement tooth prosthesis is engaged with the prosthesis engaging portion of the resin abutment via cross-linking of the resins.

8. The replacement tooth prosthesis system of claim 7, wherein the composite resin material comprises bis-GMA.

9. The replacement tooth prosthesis system of claim 7, wherein the implant fixture and abutment are fixed together by a threaded fastener having a shear strength that is greater than a shear strength of said resin abutment.

10. The replacement tooth prosthesis system of claim 7, wherein the abutment comprises a metal core with an overlying resin coating.

11. The replacement tooth prosthesis system of claim 7, wherein the abutment comprises first and second portions that are removably connectable to each other, the first portion comprising metal and the second portion comprising said composite resin material.

12. The replacement tooth prosthesis system of claim 7, wherein the composite resin material is responsive to light energy such that the application of UV, halogen, LED, plasma arc, or laser light to a surface of the resin material configures at least a portion of the resin material to a cured state.

13. A method for replacing a lost, damaged or removed tooth, comprising:
providing an implant fixture and a resin abutment member;
inserting the implant fixture into a recess in the mandible or maxilla of a patient;
fixing the resin abutment member to an upper surface of the implant fixture;
applying a composite resin tooth prosthesis to an upper surface of the resin abutment member; and
applying light energy to a surface of the composite resin tooth prosthesis to cure the prosthesis and to bond the prosthesis to the resin abutment.

14. The method of claim 13, wherein the step of applying a composite resin further comprises providing a mold over the abutment member and applying a volume of resin to an interior surface of the mold.

15. The method of claim 14, further comprising selecting the mold from a plurality of molds, wherein at least two of said plurality of molds have different sizes or shapes.

16. The method of claim 14, further comprising providing a plurality of sizing shells and a plurality of molds corresponding to said plurality of sizing shells, successively applying at least two of said plurality of sizing shells adjacent to a tooth vacancy site to determine a tooth vacancy site size or shape, and selecting the mold based on a size or shape determined during the step of applying at least two of said plurality of sizing shells.

17. The method of claim 14, wherein the mold comprises a Mylar material.

18. The method of claim 14, wherein the step of applying light energy is performed while the composite resin is located within the mold.

19. The method of claim 14, further comprising shaping an external surface of the cured prosthesis.

20. A replacement tooth prosthesis kit, comprising:
a plurality of resin abutment members, at least one of said plurality of resin abutment members having a size or shape different from at least one other of said plurality of resin abutment members;
a plurality of sizing shells configured to measure a size or shape of a tooth vacancy site;
a plurality of tooth prosthesis molds, each mold corresponding in size or shape to at least one of said plurality of sizing shells; and
a quantity of composite resin material.
